(19) United States
(12) Patent Application Publication
(10) Pub. No.: US 2024/0250558 A1
(43) Pub. Date: Jul. 25, 2024

(54) Furniture Item With Wireless Charger

(71) Applicant: La-Z-Boy Incorporated, Monroe, MI (US)

(72) Inventors: Jason BAKER, Ooltewah, TN (US); Scott JORBEL, Chattanooga, TN (US)

(73) Assignee: La-Z-Boy Incorporated, Monroe, MI (US)

(21) Appl. No.: 18/414,866

(22) Filed: Jan. 17, 2024

Related U.S. Application Data
(60) Provisional application No. 63/439,957, filed on Jan. 19, 2023.

(51) Int. Cl. H02J 50/00; A47C 7/62; A47C 17/86; A47C 31/00; H02J 50/10

(52) U.S. Cl. CPC H02J 50/005; A47C 7/624; A47C 17/86; A47C 31/00; H02J 50/10

(57) ABSTRACT

A furniture item may include a frame member and a wireless charger assembly. The frame member may include an opening. The wireless charger assembly may be mounted to the frame member. The charger assembly may include a tray, a charging unit, and a retainer. The tray may include a ledge and a mounting boss. The tray may be at least partially received in the opening of the frame member. The ledge may be sized to prevent the tray from passing entirely through the opening. The retainer may include a first portion and a second portion that is resiliently flexible relative to the first portion. The first portion may be attached to the mounting boss of the tray. The second portion may extend outwardly from the mounting boss and may engage a surface defining a periphery of the opening of the frame member.

### CROSS-REFERENCE TO RELATED APPLICATIONS

This application claims the benefit of U.S. Provisional Application No. 63/439,957, filed on Jan. 19, 2023. The entire disclosure of the above application is incorporated herein by reference.

### FIELD

The present disclosure relates to a furniture item with a wireless charger.

### SUMMARY

This section provides a general summary of the disclosure and is not a comprehensive disclosure of its full scope or all of its features.

In one form, the present disclosure provides a furniture item may include a frame member and a wireless charger assembly. The wireless charger assembly may be configured to wirelessly charge (e.g., by induction) a portable electronic device (e.g., a smartphone, tablet, etc.). The frame member may include an opening. The wireless charger assembly may be mounted to the frame member. The charger assembly may include a tray, a wireless charging unit, and a retainer. The tray may include a ledge and a mounting boss. The tray may be partially received in the opening of the frame member. The ledge may be sized to prevent the tray from passing entirely through the opening. The retainer may include a first portion and a second portion that is resiliently flexible relative to the first portion. The first portion may be attached to the mounting boss of the tray. The second portion may extend outwardly from the mounting boss and may engage an edge surface defining a periphery of the opening of the frame member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a furniture item having a wireless charger assembly;

FIG. 2 is a perspective view of the wireless charger assembly installed in a fame member of the furniture item;

FIG. 3 is a perspective view of the wireless charger assembly exploded from the frame member;

FIG. 4 is an exploded view of the wireless charger assembly;

FIG. 5 is a perspective view of an underside of the wireless charger assembly;

FIG. 6 is a side view of the wireless charger assembly;

FIG. 7 is a perspective view of an underside of a tray of the wireless charger assembly (i.e., with retainers removed); and

FIG. 8 is a partial cross-sectional view of the wireless charger assembly installed in the fame member of the furniture item.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

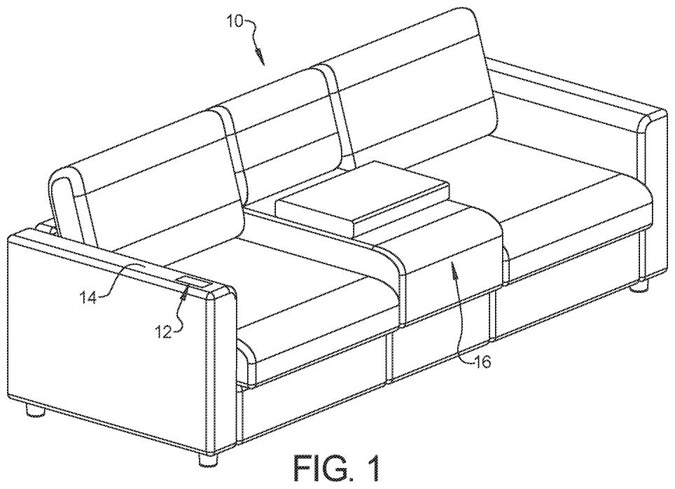

With reference to FIG. 1, a furniture item 10 is provided that may include a charger assembly 12 (e.g., a wireless charger assembly; shown schematically in FIG. 1). The furniture item 10 may be a sofa (as shown in FIG. 1) or the furniture item 10 could be a chair, a chaise, an ottoman, a table, or any other type of furniture. As shown in FIG. 1, the charger assembly 12 may be incorporated into an armrest 14 of the furniture item 10. In other embodiments, the charger assembly 12 may be incorporated into a center console 16 of the furniture item 10, for example, or any other suitable structure of the furniture item 10.

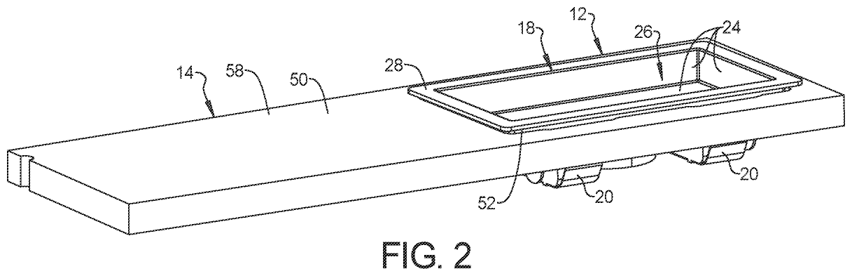

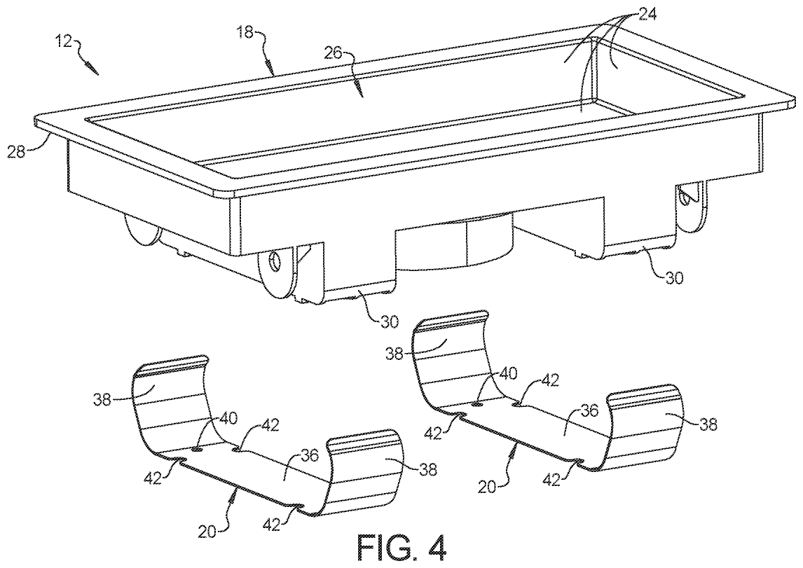

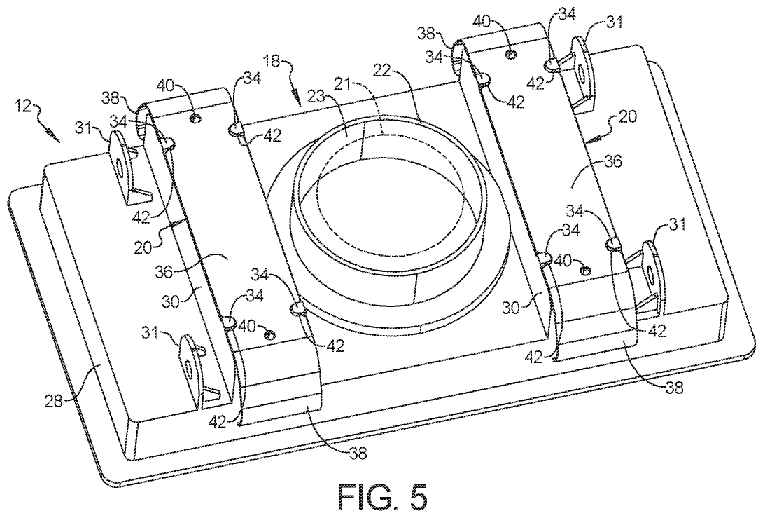

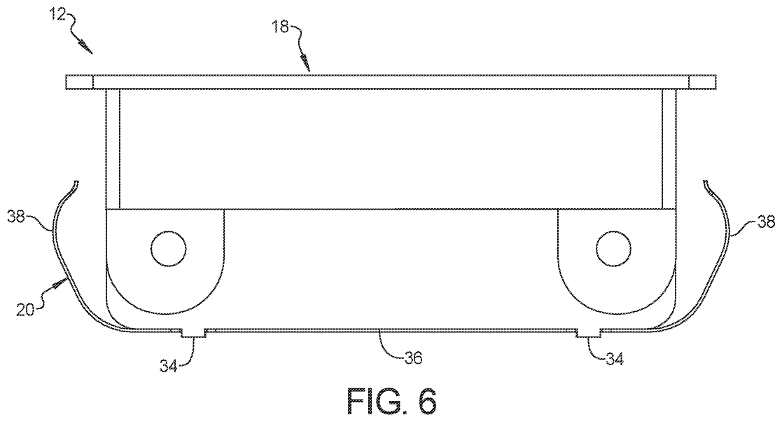

Referring now to FIGS. 2-6, the charger assembly 12 may include a tray 18, one or more retainers 20, and a charging unit 21 (shown schematically in FIG. 5). The charging unit 21 may be attached to the tray 18. For example, the charging unit 21 could be received in receptacle 22 (FIG. 5) formed on or attached to the tray 18. As shown in FIG. 5, the receptacle 22 may be a cylindrical cup-shaped member having a recess 23 that may receive the charging unit 21. The charging unit 21 may be a wireless charging unit (e.g., an induction charger) that is configured to wirelessly charge a portable electronic device (e.g., a smartphone, a tablet, or other electronic device).

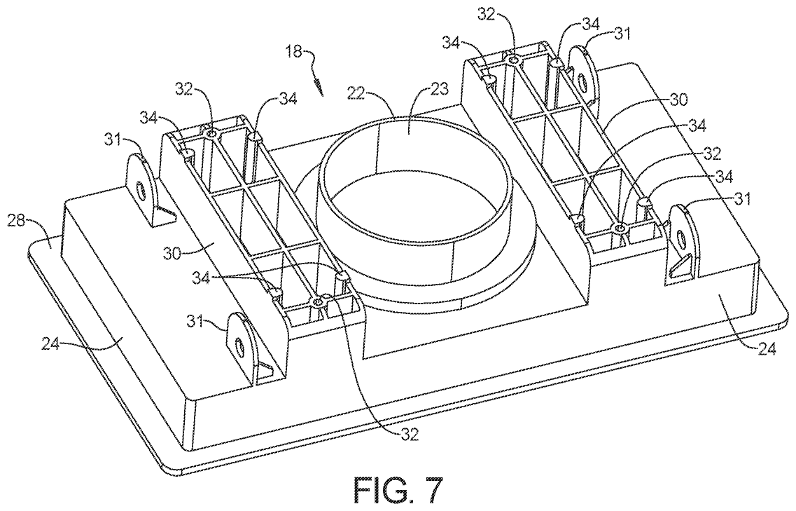

The tray 18 may be molded or otherwise formed from a plastic, wood, metal, composite, or any other suitable material. The tray 18 may include walls 24 that cooperate to define a cavity 26. The cavity 26 may be sized to allow a smartphone, tablet, or other electronic device to be received therein and lay flat against the bottom wall 24 of the cavity 26. The tray 18 may include a ledge 28 that extends outward from the walls 24 and away from the cavity 26. As shown in FIG. 7, the tray 18 may include one or more mounting bosses 30 or mounting structures that extend from an underside of the tray 18 (i.e., a side of the tray 18 opposite the cavity 26. The bosses 30 may include one or more mounting apertures 32 and/or one or more tabs or keys 34. As shown in FIGS. 5 and 7, the receptacle 22 may be disposed between two bosses 30.

In some embodiments, the tray 18 may also include mounting tabs 31 extending from the underside of the tray 18. The mounting tabs 31 may include apertures that may receive fasteners that may engage the armrest 14 or other structure of the furniture item 10.

Each of the retainers 20 may be a resiliently flexible member having a first portion 36 and one or more second portions 38. The first portion 36 may be fixedly attached to the tray 18 and the second portions 38 may be resiliently flexible (movable) relative to the first portion 36 and the tray 18. The first portion 36 may be mounted to a respective one of bosses 30. One or more fasteners (not shown) may extend through apertures 40 in the first portion 36 of the retainer 20 and may thread into (or press into) engagement with the apertures 32 of the tray 18. The first portion 36 of the retainer 20 may also include notches or openings 42 through which the tabs 34 of the tray 18 extend. The tabs 34 and notches 42 cooperate to align the retainers 20 relative to the tray 18 and restrict or prevent the retainers 20 from unintended shifting relative to the tray 18.

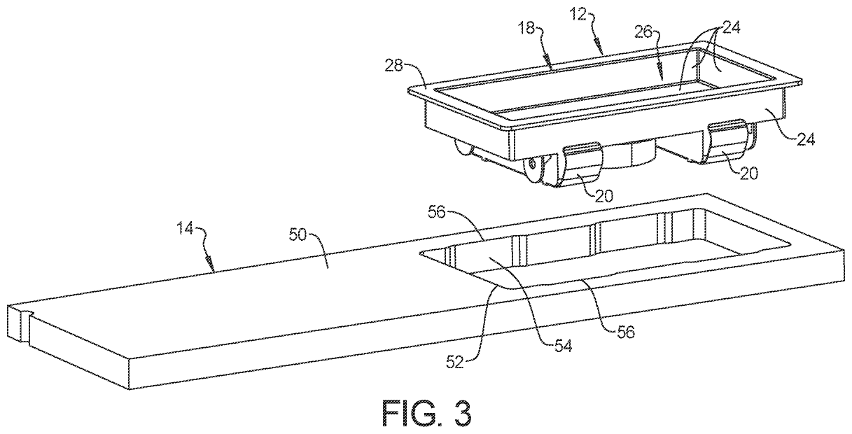

As shown in FIGS. 2 and 3, the armrest 14 (or other structure of the furniture item 10 into which the charger assembly 12 is installed) may include a frame member 50 (e.g., a board or rail) having an opening 52 that extends through opposing surfaces of the frame member 50. The opening 52 is shaped and sized large enough to allow the walls 24 and bosses 30 of the tray 18 to be inserted through the opening 52 but small enough to prevent the ledge 28 from passing through the opening 52. In other words, the ledge 28 is sized and shaped so that it cannot pass through the opening 52 while the walls 24 are received within the opening 52., as shown in FIG. 2. For example, a perimeter of the ledge is greater than the perimeter of the opening.

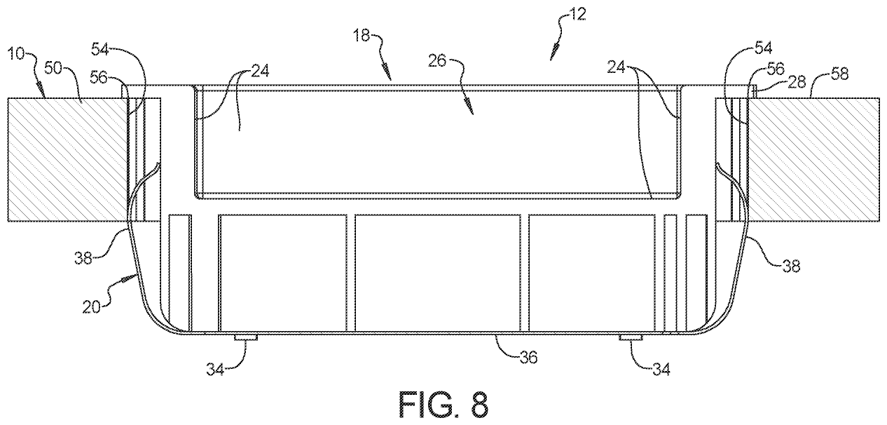

As the tray 18 is inserted into the opening 52 of the frame member 50, the second portions 38 of the retainers 20 may resiliently bend inward toward the walls 24 and cavity 26 of the tray 18. When the tray 18 is fully installed within the opening 52 of the frame member 50, the second portions 38 of the retainers 20 contact edge surfaces 54 (i.e., surfaces defining the periphery of the opening 52; shown in FIG. 3) and exert a force against the edge surfaces 54 that retain the tray 18 relative to the frame member 50. In some embodiments, when the tray 18 is fully installed within the opening 52 of the frame member 50, the ledge 28 of the tray 18 may contact a surface 58 (or upholstery covering the surface 58) of the fame member 50 surrounding the opening 52, as shown in FIG. 8. The tray 18 can be removed (e.g., for service or replacement of the charger assembly 12) by compressing some or all of the second portions 38 of the retainers 20 inward toward the walls 24 of the tray 18 to allow the tray 18 to be freely removed from the opening 52.

In some configurations, the opening 52 may include notches or cutouts 56 that are aligned with and engage the second portions 38 of the retainers 20, as shown in FIG. 3.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A furniture item comprising:
a frame member including an opening;
a wireless charger assembly mounted to the frame member and configured to wirelessly charge a battery-powered electronic device,
wherein the wireless charger assembly includes a tray, a charging unit, and a retainer,
wherein the tray includes a ledge and a mounting boss, wherein the tray is at least partially received in the opening of the frame member and the ledge is sized to prevent the tray from passing entirely through the opening, and
wherein the retainer includes a first portion and a second portion that is resiliently flexible relative to the first portion, wherein the first portion is attached to the mounting boss of the tray, and wherein the second portion extends outwardly from the mounting boss and engages a surface defining a periphery of the opening of the frame member.

2. The furniture item of claim 1, wherein the frame member is an armrest of the furniture item.

3. The furniture item of claim 1, wherein the first portion of the retainer is fixedly attached to the frame member.

4. The furniture item of claim 3, wherein the first portion of the retainer includes an opening that receives a tab formed on the mounting boss.

5. The furniture item of claim 4, wherein the second portion of the retainer extends from a first end of the first portion, wherein the retainer includes a third portion that is resiliently flexible relative to the first portion and extends from a second end of the first portion, and wherein the third portion extends outwardly from the mounting boss and engages the surface defining the periphery of the opening of the frame member.

6. The furniture item of claim 5, wherein a cavity is formed in a first side of the tray.

7. The furniture item of claim 6, wherein the mounting boss is formed on a second side of the tray, and wherein the second side is opposite the first side.

8. The furniture item of claim 7, wherein the second and third portions of the retainer extend from the mounting boss toward the ledge of the tray and wherein the cavity is disposed between distal ends of the second and third portions.

9. The furniture item of claim 8, wherein the tray includes a receptacle formed on the second side of the tray.

10. The furniture item of claim 9, wherein the charging unit is housed within the receptacle, and wherein a bottom wall of the cavity separates the cavity from the receptacle.

11. The furniture item of claim 10, wherein the tray includes another mounting boss to which another retainer is attached, and wherein the receptacle is disposed between the mounting bosses.

12. A furniture item comprising:
a frame member including an opening;
a charger assembly mounted to the frame member,
wherein:
the charger assembly includes a tray, a charging unit, and a pair of retainers,
the tray includes a ledge and a pair of mounting bosses,
the mounting bosses are sized to allow the mounting bosses to pass through the opening,
the tray is at least partially received in the opening of the frame member and the ledge is sized to prevent the tray from passing entirely through the opening,
each of the retainers includes a first portion and a second portion that is resiliently flexible relative to the first portion,
the first portion of each retainer is attached to a respective one of the mounting bosses of the tray, and
the second portion of each retainer extends outwardly from the respective mounting boss and engages a surface defining a periphery of the opening of the frame member.

13. The furniture item of claim 12, wherein the frame member is an armrest of the furniture item.

14. The furniture item of claim 12, wherein the first portions of the retainers are fixedly attached to the frame member.

15. The furniture item of claim 14, wherein the first portion of each retainer includes an opening that receives a tab formed on the respective mounting boss.

16. The furniture item of claim 15, wherein the second portion of each retainer extends from a first end of the respective first portion, wherein each retainer includes a third portion that is resiliently flexible relative to the first portion and extends from a second end of the respective first portion, and wherein the third portion extends outwardly from the respective mounting boss and engages the surface defining the periphery of the opening of the frame member.

17. The furniture item of claim 16, wherein a cavity is formed in a first side of the tray.

18. The furniture item of claim 17, wherein the mounting bosses are formed on a second side of the tray, and wherein the second side is opposite the first side.

19. The furniture item of claim 18, wherein the second and third portions of each retainer extend from the respective mounting boss toward the ledge of the tray, and wherein the cavity is disposed between distal ends of the second and third portions.

20. The furniture item of claim 8, wherein the tray includes a receptacle formed on the second side of the tray, wherein the charging unit is housed within the receptacle, wherein a bottom wall of the cavity separates the cavity from the receptacle, and wherein the receptacle is disposed between the mounting bosses.
